(19) United States
(12) Patent Application Publication
(10) Pub. No.: US 2007/0278194 A1
(43) Pub. Date: Dec. 6, 2007

(54) Laser Device And Operating Method

(75) Inventors: Manfred Hoelsher, Ziemetshausen (DE); Anton Englhard, Petersdorf/Schoenleiten (DE)

Correspondence Address: MCGLEW & TUTTLE, PC, P.O. BOX 9227, SCARBOROUGH STATION, SCARBOROUGH, NY, 10510-9227, US

(73) Assignee: KUKA SCHWEISSANLAGEN GMBH, Augsburg (DE)

(21) Appl. No.: 11/572,646

(22) PCT Filed: Aug. 4, 2005
(86) PCT No.: PCT/EP05/08456

§ 371 Date: Jan. 25, 2007

(30) Foreign Application Priority Data
Aug. 5, 2004 (DE) 10 2004 038 310.3

(51) Int. Cl. B23K 26/02

(52) U.S. Cl. 219/121.6

(57) ABSTRACT

A laser device (6) and a corresponding operating method are provided. The laser device (6) is provided with a laser tool (7) including a laser lens system (13) with focussing and collimating lenses and, optionally, a divergent lens (35) and a connector (19) for an optical fiber (11) with a fiber decoupling point (12). The focal length (Ff) of the focussing lens (14) is altered by adjusting the optical separation (b) of the fibre decoupling point (12) from the collimating lens (15) by means of an adjuster device (21).

### CROSS REFERENCE TO RELATED APPLICATIONS

This application is a United States National Phase application of International Application PCT/EP2005/008456 and claims the benefit of priority under 35 U.S.C. § 119 of German Patent Application DE 10 2004 038 310.3 filed Aug. 5, 2004, the entire contents of which are incorporated herein by reference.

### FIELD OF THE INVENTION

The present invention pertains to a laser device and a method for operating a laser device.

### BACKGROUND OF THE INVENTION

Such laser devices are known from practice. They have at least one laser tool, which has a laser lens system with a focussing lens and a collimating lens as well as a connector for an optical fiber. The optical fiber has a fiber decoupling point, at which the laser beam exits. The prior-art laser tools have fixed focal lengths of the laser lens system. To have the focus of the laser beam at the desired point in the workpiece and to generate a focal point of the desired size, it is necessary in this state of the art to affect the working distance between the laser tool and the workpiece. This is necessary, for example, when the laser tool changes its orientation in relation to the workpiece and the laser beam falls on the workpiece with variable angles. The laser tool, moved by a manipulator, especially a multiaxial robot, is usually correspondingly adjusted mechanically for this purpose.

Fiber-coupled laser sources, e.g., disk lasers or fiber lasers with high beam quality (small beam parameter product) have, as a rule, small fiber core diameters, which are, e.g., smaller than 0.2 mm. The still tolerable deviation of the position of the focus in the direction of the beam (so-called Rayleigh length) decreases considerably because of this small fiber core diameter. In case of a fiber laser with a beam parameter of 4.3 mm×mrad and a fiber core diameter of 0.1 mm, a still tolerable focal deviation of approx. ±10 mm is obtained in the axial beam direction for a laser lens system with a focal length of 1,400 mm and a collimation length of 330 mm. This narrow tolerance range can be rapidly exceeded and lead to adjustment of the laser tool by corresponding motions of the manipulator or robot in case of the changes in orientation of the laser tool. This makes programming of the manipulator difficult. In addition, the narrow focus tolerance makes it obligatory to use higher-quality manipulators with a larger number of axes, e.g., six-axis manipulating systems. However, the inaccuracy of the path also increases with increasing number of axes. This makes it necessary to use higher-quality manipulators, especially six-axis articulated arm robots. This leads to higher costs and also to an increased space requirement compared to simpler manipulating systems with a smaller number of axes.

The fixed focal lengths of the laser lens system restrict the possibilities of motion of the manipulator or robot because they require that a fixed, preset working distance be complied with. Depending on the application, this may lead to problems because of limited working spaces or for other reasons. The only way out that is left is to replace the laser lens system and to change the focal length. This requires more time and higher costs. In addition, it continues to be necessary to maintain a preset working distance even if the lens system is changed due to the fact that the focal length is invariably fixed.

### SUMMARY OF THE INVENTION

The object of the present invention is to provide an improved laser technique.

With the method and device technology according to the present invention, the focal length Ff of the focussing lens system can be changed in a simple manner, and the focal length can be changed rapidly, in a short time and during the operation. As a result, the laser tool can change its working distance in relation to the workpiece in a broad range of adjustment and it becomes highly flexible as a result. This simplifies the programming of manipulators and robots. Adjustment of the focal length and of the focus can be carried out very rapidly and precisely even in case of changes in the orientation of the laser tool, without the manipulator or robot having to perform mechanical motions for this.

The change in the focal length can be performed by adjusting the optical distance b of the fiber decoupling point or by adjusting the collimation length. This is possible in various ways, and one or more adjuster devices may be arranged at the connector of the optical fiber at the laser tool and/or at the collimating lens or the laser lens system and/or at a divergent lens introduced into the beam path. Only small masses must be moved for this, so that a relatively weak drive technology is sufficient, which can react correspondingly rapidly and precisely. In addition, it is favorable that a positive transmission ratio is given for changing the focal length. Small changes in the optical distance b lead to relatively great changes in the focal length. This transmission ratio is, in turn, favorable for the speed and the accuracy of adjustment of the adjuster device.

The laser technique according to the present invention offers the possibility of embodying an autofocus system, which makes possible the highly accurate and fast adjustment of the focal point or the focal spot on the workpiece in the processing operation. Furthermore, it is possible to maintain the desired size of the diameter of the focal spot on the workpiece.

In addition, there are favorable effects on the improvement and the operation of the speed of processing, especially of the speed of welding during laser welding. The low-weight and fast autofocus system offers higher accuracies and speeds of response than the substantially more sluggish manipulator. This is especially advantageous when the laser tool is guided by a manipulator or robot with variable orientations and laser incidence angles at the workpiece, and changes in orientation preferably take place via motions of a hand axis. Despite the steadily and very rapidly changing orientations and incidence angles, the autofocus system permits highly precise adjustment of the focal point at the workpiece.

The higher the beam quality of the laser source and the smaller the fiber core diameter becomes, the greater is the effect of these advantages of the autofocus system. The tolerance problems experienced up to now with the Rayleigh length can be overcome hereby. Improved possibilities of use arise above all for laser lens systems with a longer initial focal length. These laser tools are used as so-called remote lasers and have correspondingly great working distances from the workpiece, the laser beam being moved predominantly by changing the orientation of the laser tool and by angular motions along the path to be followed at the workpiece.

The laser technique of the invention permits, moreover, focus shift compensation. Temperature-dependent changes in the lens system and shifts in the focal point associated herewith in the direction of the beam can now be compensated. This can happen automatically in a control automatically as a function of the temperature of the lens system or at certain maintenance intervals by manual adjustment.

Due to the fact that the focal length can be changed easily, the laser tool can cover a broad range of focal distances and a correspondingly broad range of variations in the working distances. The changing of the lens, which was hitherto necessary, can now be completely eliminated or reduced to a lower extent. In particular, the same laser tool can now be used both at close range and in the remote range as a remote laser. In addition, it is possible due to the adjustment of the focal length to simplify the manipulator and to equip it with fewer axes.

Furthermore, the laser technique being claimed offers advantages in setting up and teaching the laser device. A pilot laser with a coupled pilot laser beam can now be used in the optically visible wavelength range. The differences between the wavelengths of the pilot laser beam and the working laser beam and the differences in the refraction and focussing characteristics that are associated therewith can be compensated by means of the adjuster device and the adjustment of the focal length by means of an offset in the adjuster device. As a result, teaching is possible in an especially simple manner, rapidly and reliably. Complicated distance-measuring systems and the like are dispensable. In particular, the tool center point (TCP) of the laser tool, which is usually located in the focus, can be taught highly accurately and simply. The correlation and mathematical combination between the change in the optical distance b and the change in the focal length as well as the corresponding mathematical combination with the manipulator or robot control can be taught equally simply and reliably. Due to the adjuster device being connected to the manipulator or robot control, the changes in focal length can be carried out and used adequately for the process when needed in an optimal manner.

The possibility of setting and controlling the diameter of the focal spot at the workpiece in a purposeful manner during the change in the focal length is also an important aspect of the present invention. This diameter can be maintained at a constant value via the autofocus function even in case of changes in the working distance of the laser tool from the workpiece. As a result, the amount of energy introduced into the workpiece locally can also be maintained at a constant value, which is of significance for various laser processes, e.g., laser welding. However, depending on the needs of the process, it is also possible to change the diameter of the focal spot purposefully in order to also vary as a result the amount of energy introduced. The change in the amount of energy introduced may depend, e.g., on changes in the relative velocity of motion of the focal spot at the workpiece and may be adjusted thereto. Likewise, adjustment to different incidence angles of the laser beam at the workpiece is also possible. The smaller the incidence angle between the laser beam and the workpiece surface, the larger will become the diameter of the focal spot in the projection and the smaller will become the amount of energy introduced. The amount of energy introduced is affected, besides, by an angle-dependent coupling characteristic of the laser beam on the workpiece surface. To counter these changes or to make adjustment to them, the focal spot diameter can be affected and, e.g., reduced by a change in the focal length. This change in the focal length can likewise take place in the autofocus operation via a mathematical combination with the continuous-path control of the manipulator.

Arrangement of a divergent lens in the beam path in front of the collimating lens may be advantageous for high beam qualities of the laser beam and the small divergence angles associated therewith in order to obtain a sufficiently large beam diameter at the collimating lens and the focussing lens especially for long focal lengths. A movable divergent lens with an adjuster device of its own offers, moreover, additional possibilities of affecting the diameter of the focal spot at the workpiece. It is favorable for this to move the divergent lens together with the connector of the optical fiber or with the collimating lens or the laser lens system comprising the collimating lens and the focussing lens axially in the beam path. As a result, a broad performance graph is obtained, in which the diameter of the focal spot can be changed and adapted to the needs of the process as desired. The adjustment of the divergent lens also has a relatively small effect on the focal length, which can be additionally utilized or, if not needed, compensated by corresponding motions of the optical fiber connector and/or the collimating lens or the laser lens system in the opposite direction.

The present invention is schematically shown in the drawings as an example. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a schematic view of a laser cell with a manipulator and a laser device;

FIG. 2 is a schematic side view of a laser tool;

FIG. 3 is a schematic view showing one of different states in case of changes in the focal length;

FIG. 4 is a schematic view showing another of different states in case of changes in the focal length;

FIG. 5 is a schematic view showing another of different states in case of changes in the focal length;

FIG. 6 is a schematic view showing a step of the procedure during the teaching of the laser tool;

FIG. 7 is a schematic view showing another step of the procedure during the teaching of the laser tool;

FIG. 8 is a schematic view showing another step of the procedure during the teaching of the laser tool;

FIG. 9 is a schematic side view showing a variant of the laser tool from FIG. 2 with a divergent lens and a plurality of adjuster devices;

FIG. 10 is a schematic view showing an example of adjustment for the adjustment of the fiber connector and the laser lens system;

FIG. 11 is a schematic view showing another example of adjustment for the adjustment of the fiber connector and the laser lens system;

FIG. 12 is a schematic view showing an example of adjustment for the adjustment of the divergent lens and the laser lens system;

FIG. 13 is a schematic view showing another example of adjustment for the adjustment of the divergent lens and the laser lens system;

FIG. 14A is a schematic view showing an example of affecting the diameter of the focal spot;

FIG. 14B is diagram of the focus diameter (ø Fok) related to the working distance;

FIG. 15A is a schematic view showing another example of affecting the diameter of the focal spot;

FIG. 15B is diagram of the focus diameter (ø Fok) related to the working distance;

FIG. 16A is a schematic view showing another example of affecting the diameter of the focal spot;

FIG. 16B is diagram of the focus diameter (ø Fok) related to the working distance;

FIG. 17A is a schematic view showing another example of affecting the diameter of the focal spot;

FIG. 17B is diagram of the focus diameter (ø Fok) related to the working distance;

FIG. 18A is a schematic view showing another example of affecting the diameter of the focal spot;

FIG. 18B is diagram of the focus diameter (ø Fok) related to the working distance;

### DESCRIPTION OF THE PREFERRED EMBODIMENTS

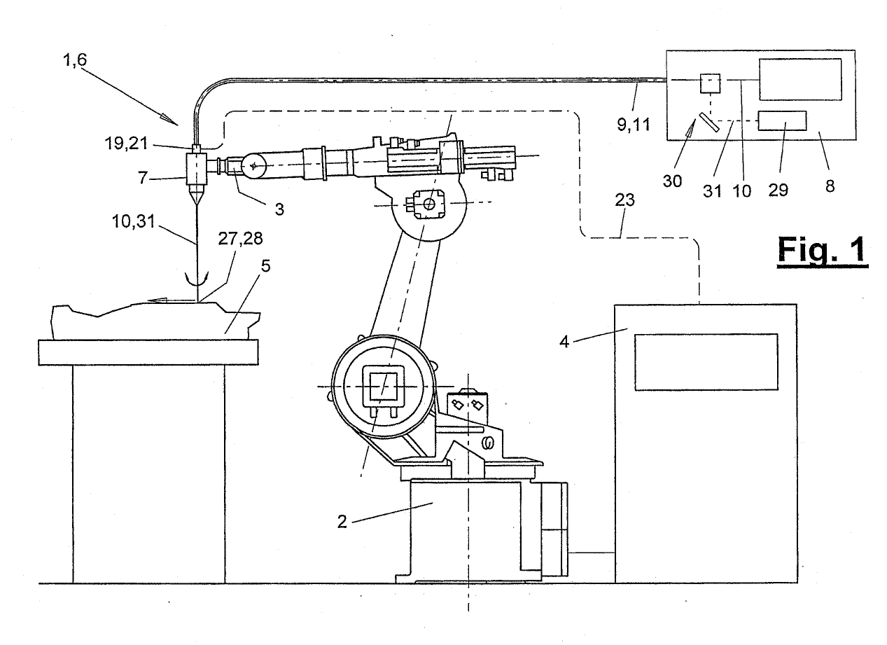

Referring to the drawings in particular, FIG. 1 shows, in a schematic side view, a laser cell (1), which is equipped with a laser device (6). One or more workpieces (5) are processed in the laser cell (1) with one or more laser beams (10) in any desired manner. These may be, e.g., welding or soldering processes, cutting processes, edge rounding processes or the like.

The laser device (6) comprises at least one laser tool (7). This is connected in the embodiment shown to a manipulator (2), which may have as many axes as desired. In the embodiment being shown, it is a six-axis articulated arm robot with a multiaxial robot hand (3), to which the laser tool (7) is attached. The robot is a higher-quality and multiaxial embodiment of a manipulator (2). As an alternative, the manipulator (2) may also have a different design, e.g., it may be designed as a linear cross slide system with two axes or the like. The manipulator (2) has only one axis in the simplest case. The axis (axes) may be of any desired type and a combination of rotatory and/or translatory axes.

The manipulator (2) has a control (4), which is designed as a robot control in the embodiment being shown. Among other things, a preprogrammed path, along which the manipulator (2) guides the laser tool (7) relative to the workpiece (5), is stored in the programmable control (4), which is equipped with corresponding computing units as well as memories.

In a variant, not shown, the laser tool (7) may be arranged stationarily, and the manipulator (2) guides a workpiece (5) relative to the laser tool (7). The laser tool (7) and the laser workpiece (5) may be moved by two manipulators (2) in relation to one another in a third variant.

The laser device (6) comprises, furthermore, at least one laser source (8), in which at least one working laser beam (10) is generated and sent to the laser tool (7) via a line (9). A plurality of laser tools (7) with a common laser source (8) and a beam switching means may be present in the laser cell (1). The line (9) may have any desired, suitable design. It may be an optical cable, a tube and mirror system or any other embodiment as desired. At least at the end of the line (9), the laser beam is decoupled into an optical waveguide (11), which is preferably designed as an optical fiber. The optical waveguide (11) may also extend up to the laser source (8). The laser beam (10) exits at a fiber decoupling point (12) at the front end of the optical waveguide (11). The diameter of the optical fiber or of the so-called fiber core is preferably smaller than 0.2 mm. It is 0.1 mm in an especially favorable embodiment.

The laser source (8) may be of any desired, suitable design. It is preferably a disk laser or fiber laser with a high beam quality. This results in strong beam bundling and low divergence of the laser beam (10). The divergence or the so-called beam parameter product is preferably lower than 5. It is defined as the product of ¼ fiber core diameter× laser beam divergence angle.

The diameter of the focal point (28), with which the laser beam (10) falls on the surface of the workpiece (5), should be within a certain range due to the process. This focal point diameter is also called spot diameter. For example, a spot diameter of approx. 0.6 mm is advantageous for welding. This spot diameter is calculated as the product of the fiber core diameter and the quotient of the focal length Ff to the collimation focal length Fk. The smaller the fiber core diameter at the desired spot diameter, the greater is, in proportion, the focal length. As an alternative or in combination, the collimation focal length may be reduced as well. Furthermore, it is possible to affect the spot diameter by a divergent lens (35).

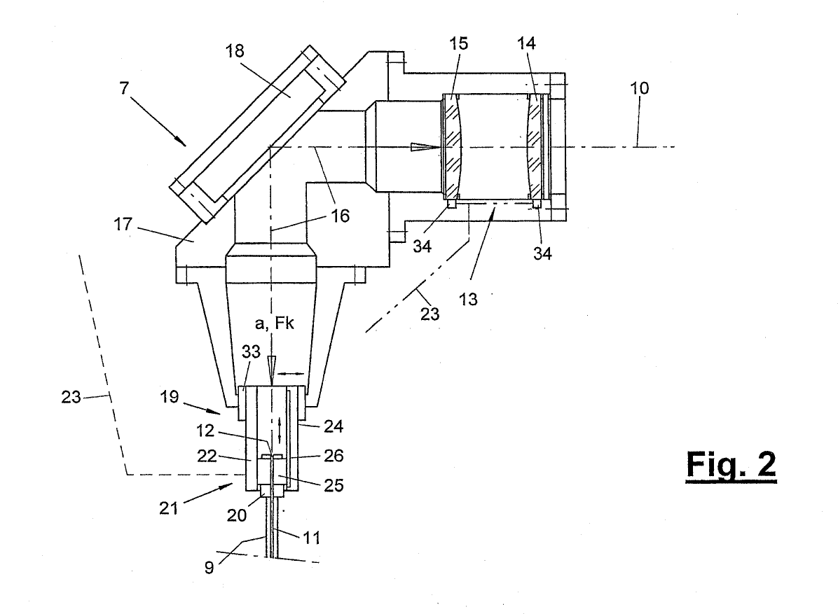

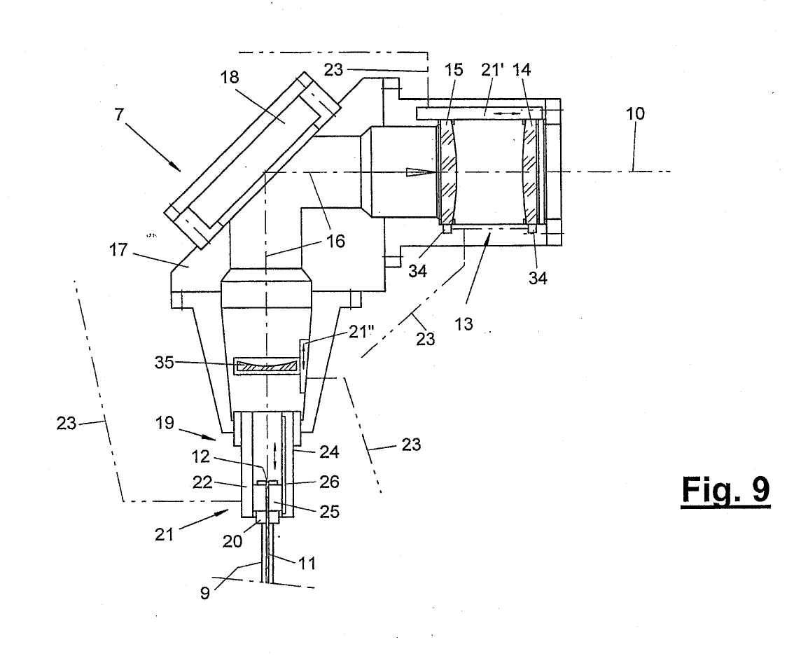

The laser tool (7) shown in FIG. 2 has a housing (17), which can be connected to the robot hand (3) or another manipulator connector and in which a laser lens system (13) with a focussing lens (14) and a collimating lens (15) as well as connector (19) for the optical waveguide (11) are arranged. Moreover, a divergent lens (35) is arranged in the beam path (16) between the connector (19) for the optical waveguide (11) and the collimating lens (15) in the variant according to FIG. 9.

The lenses (13, 14, 15, 35) may have any desired design; for example, they may be transmissive optical systems, e.g., lenses, or reflective optical systems, e.g., mirrors. Lens systems are used in the exemplary embodiments being shown.

The housing (17) is bent at an angle in the embodiments shown, and the laser beam is deflected at an oblique mirror (18). As an alternative, the housing (17) may have a stretched shape without a mirror. The laser lens system (13) is preferably arranged stationarily in the housing (17). It is advantageous now if the collimating lens (15) is located close to the focussing lens (14). In the embodiment shown in FIG. 2, both lenses (14, 15) are arranged in the close proximity of a housing leg at a spaced location behind the mirror (18) when viewed in the direction (16) of the beam.

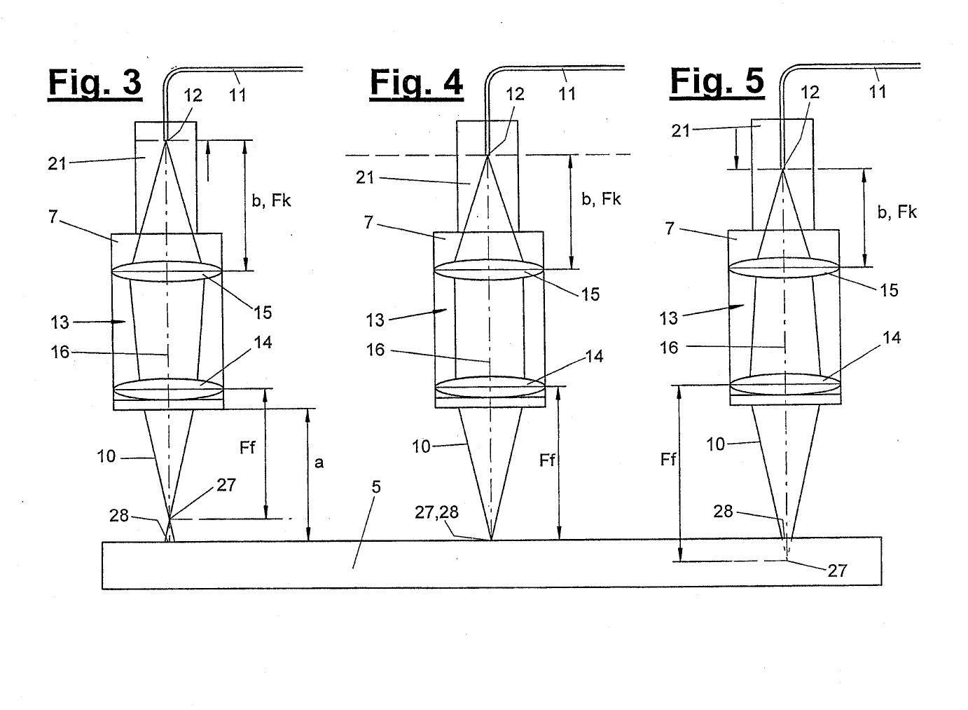

The laser tool (7) has at least one adjuster device (21, 21′) for adjusting the optical distance b of the fiber decoupling point (12) from the collimating lens (15). The change in distance brings about a change in the angle of the laser radiation behind the collimation because of the widening of the beam and the changed incidence angle on the collimating lens (15). FIGS. 3 through 5 illustrate this schematically. Depending on the direction of shift, the laser radiation becomes divergent or convergent. The change in the angle of the laser radiation also has an effect behind the focussing lens (14). A change in the beam into the divergent or convergent range also takes place here, as a consequence of which there is a shift in the location of the focus in the beam direction (16). Adjustment of the optical distance b in the beam direction (16) thus leads to a change in the focal length Ff of the focussing lens (14).

The relative adjustment of the optical distance b can be carried out in different ways. In one exemplary embodiment, shown in FIGS. 1 through 8, the adjuster device (21) is arranged at the connector (19) and shifts the fiber decoupling point (12) in the beam direction (16). As an alternative or in addition, the collimating lens (15) may be shifted by a corresponding adjuster device (21′) in the beam direction (16) according to a variant shown in FIG. 9. The collimating lens (15) is preferably shifted now together with the focussing lens (14), i.e., the entire laser lens system (13).

FIG. 9 shows, moreover, a variant in which a divergent lens (35) is arranged in the beam path (16) between the connector (19) for the optical fiber and the collimating lens (15). This divergent lens (35) brings about a widening of the laser beam (10) exiting from the decoupling point (12) and an increase in the divergence angle. The divergent lens (35) is preferably arranged for this purpose close to the fiber decoupling point (12) and in the beam direction (16) in front of the deflecting mirror (18). The widening of the laser beam (10) likewise brings about a change in focal length. This effect is, however, weaker than the effect from the change in the optical distance b. Above all, the divergent lens (35) implies a change in the spot diameter in the focal point (28). The divergent lens (35) may have an adjuster device (21″) of its own for this purpose. As an alternative, it may be mounted movably and shifted together with the fiber decoupling point (12) or the collimating lens (15) or the entire laser lens system (13) via a coupling.

The adjuster device (21) has a controllable linear drive (22), which permits the axial shift of the fiber decoupling point (12) in the beam direction (16). The controllable linear drive (22) is designed as a so-called linear axis. It has, e.g., a hollow drive housing (24), which is directed along the beam direction (16). An adjusting member (25), to which the optical waveguide (11) is attached, is arranged in the interior of the drive housing (24). The adjusting member (25) can be shifted axially in the beam direction (16) by means of a corresponding drive element. The drive may be of any desired, suitable design, e.g., with an inductive linear drive, a hollow spindle drive or the like. Electric motor components, such as coils, electric motors or the like, may be considered as motor drive elements. However, the linear drive (22) may have basically any desired and suitable design.

At its free end, the optical waveguide (11) has a fiber mount (20), which is designed, e.g., as a fiber plug, and the fiber decoupling point (12) is arranged at the front end of the fiber mount. The fiber plug is attached to the adjusting member (25) preferably detachably and is moved by this forward and backward by means of a motor in the beam direction (16). The directions of motion are illustrated by arrows. The fiber plug is preferably held on the inner side at the adjusting member (25), so that the decoupling point (12) is exposed and makes possible the free and unhindered exit of the laser beam (10).

The linear drive (22) has a measuring means (26) for measuring the path of the adjusting member (25). Accurate positioning of the adjusting member (25) in the desired position and for setting the optical distance b can also be performed hereby. The optical distance b can be seen in the schematic views in FIGS. 3 through 5.

The linear drive (22) is connected to the control (4) in the above-mentioned manner by means of a line (23), especially an electric signal or control line. As an alternative, the data transmission may also take place in a wireless manner via radio, infrared light or the like. In another variant, the linear drive (22) may contain a complete control of its own or at least parts of such a control and equipped for this purpose with at least one computing unit or with at least one memory for programs, measured path values and offset values (32), which latter will be explained later.

The adjuster device (21) can be remote-controlled via the control. The actuation may be carried out now fully automatically via an integrated or external control (4) or also manually by a human operator by means of corresponding operating keys or other input means.

The adjusting drives (21′, 21″) of the collimating lens and laser lens system (15, 13) and of the divergent lens (35) may have the same design as the adjusting drive (21) of the fiber decoupling point (12) in the same, above-described manner. The lenses (13, 15, 35) have correspondingly suitable, axially movable mounts in the housing (17). The different adjuster devices (21, 21′, 21″) may be controlled independently, e.g., separate controls of their own or via a common control (4). However, there may be interdependence, which will be discussed in more detail later.

Furthermore, an adjusting means (33), which makes possible the transverse positioning of the linear drive (22) and thus the transverse adjustment of the laser beam (10) in relation to the laser lens system (13) and to an outlet nozzle that may possibly be present at the front end of the laser tool (7), maybe arranged at the connector (19). The adjusting means (33) may be able to be operated manually. As an alternative, it may have a suitable adjusting drive. Adjustment possibilities are possible in the transverse plane in relation to the beam path (16) along preferably two axes.

Changes in the paths of the adjuster device(s) (21, 21′, 22″) and a corresponding change in the optical distance b lead to substantially greater changes in the distance between the focus (27) and the focussing lens (14) and in the focal length Ff of the focussing lens (14) due to an optical increase. It is advantageous for this if the focussing lens (14) in the optical structure of the lenses and other optical elements is provided with a greater initial focal length of preferably at least 500 mm or more. In addition, the focal length Fk of the collimating lens (15) is preferably smaller than the focal length FE In a practical embodiment, the focal length Ff is, e.g., more than 1,000 mm, e.g., 1,400 mm, and the collimation focal length Fk is approx. 300 mm, e.g., 330 mm. Small axial shifts of the adjuster device(s) (21, 21′, 21″) of, e.g., 20 mm can lead to great changes in focal lengths and focus shifts of more than 1 m with such optical ratios. The length of adjustment of the adjuster device(s) (21, 21′, 21″) and of the linear drive (22) is selectable and is coordinated with the desired range of variation of the focal length FE

The adjuster device(s) (21, 21′, 21″) may form an autofocus system. The motions of the adjuster device(s) (21, 21′, 21″) or of the linear drive or linear drives (22) and of the manipulator (2) can be mathematically combined with one another for this in the control. As a result, the control (4) controls the axial motions of the linear drive (22) and knows, conversely, the position and the axial paths of the fiber decoupling point (12) and/or the collimating lens and/or the divergent lens (35) and thus also the optical distances b from the collimating lens (15), which can be changed on this basis. The motions of the adjuster device(s) (21, 21′, 22″) and of the manipulator (2) can be coupled via the mathematical combination. Shifting of the focus (27) in the beam direction (16) can be achieved as a result both by a corresponding motion of the manipulator in the beam direction (16) and by changing the optical distance b and a change in the focal length Ff which is associated therewith. These possibilities of influencing may be carried out alternatively or combinatively and are affected by the control (4).

FIGS. 3 through 5 illustrate the changes in the focal length Ff due to a change in the optical distance b due to a shift of the fiber decoupling point (12). FIG. 4 shows the ideal case, in which the focus (27) is located in the focal point (28) or in the immediate vicinity thereof at the workpiece (5), so that the spot diameter necessary or desired for the particular processing process is obtained. The working distance a between the laser tool (7) and the workpiece surface with the focal point (28) is correspondingly great now.

There is an overfocussing in the variant according to FIG. 3. At equal working distance a, the focus (27) is located above the workpiece surface, so that the laser beam (10), which is again divergent after the focus (27), forms a focal point (28) with an enlarged spot diameter on the workpiece surface. As is apparent from the comparison of FIGS. 3 and 4, this overfocussing is brought about by an outward motion of the fiber decoupling point (12) and an increase in the optical distance b. Corresponding to the overfocussing, the focal length Ff becomes shorter as well.

FIG. 5 shows the other case, that of underfocussing, when the focus (27) is located under the focal point (28) and thus inside the workpiece (5). The focal length Ff is increased in his case. This is associated with an inward motion of the fiber decoupling point (12) and a corresponding shortening of the optical distance b. The working distance a of the laser tool (7) is otherwise the same as in the other two views in FIGS. 3 and 4 as well.

The adjuster device (21) can be used in various ways. On the one hand, the focus (27) may be located, in the manner described in the introduction, exactly on the workpiece surface (5) and in the focal point (28) or at least in the immediate vicinity thereof. On the other hand, it is possible to set the spot diameter of the focus (28) to desired values and to reduce or increase it. Allowance can be made for different needs of the process due to this change in diameter. For example, the spot diameters used for welding are different from those used for cutting or soldering. In addition, a change in diameter may also be meaningful within a laser process. As a result, allowance can be made for different seam geometries, e.g., during welding. Furthermore, it is possible to respond to variable incidence angles of the laser beam (10) at the workpiece (5) and to a correspondingly changed coupling characteristic. In addition, the amount of energy introduced at the workpiece (5) can be controlled in the desired manner. An increased spot diameter reduces the energy density. The heating behavior at the workpiece changes due to a change in the energy density, which affects, e.g., the melt formation or the like. For example, it is also possible to react to different materials by varying the spot diameter.

The changes in the optical distance b and the focal length Ff which are shown in FIGS. 3 through 5 can be achieved, as an alternative, by shifting the collimating lens (15) in the beam direction (16). It is possible in another variant to shift both the fiber decoupling point (12) and the collimating lens (15) and to coordinate the two shifting motions with one another by an internal or external control (4). If the focussing lens (14) is also shifted to the same extent with the collimating lens (15), a focus shift associated with the motion of the focussing lens is, moreover, to be taken into account in the control.

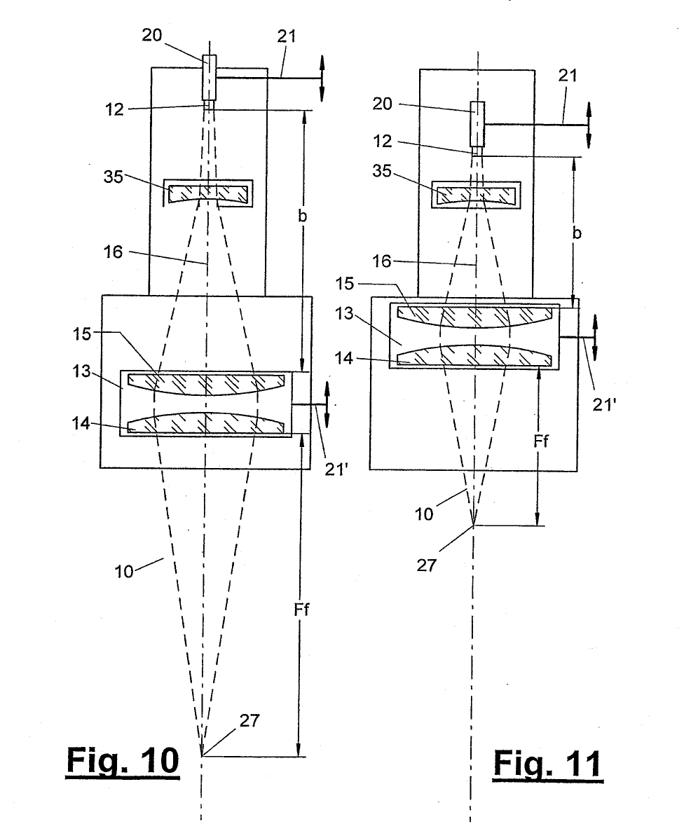

FIGS. 10 and 11 show such a variant in connection with a divergent lens (35) and adjuster devices (21, 21′, 21″) at the fiber mount (20) and at the laser lens system (15). The divergent lens (35) remains stationary in the beam path in this exemplary embodiment. FIG. 10 shows the variant with a great optical distance b and a correspondingly great focal length Ff. FIG. 11 illustrates the optical distance b reduced by the approachment of the fiber mount (20) and the laser lens system (13) to one another and the shortening of the focal length Ff, which is associated herewith. Moreover, it appears from FIGS. 10 and 11 that the adjusting drives (21, 21′) may have relatively short adjusting paths in the same direction or in different directions, but substantially greater changes in the optical distance b can be achieved due to the superimposition of these paths, especially in case of opposite directions of motion. This double possibility of adjustment is favorable for the minization of the overall size of the laser tool (7). The divergent lens (35) also has a favorable effect in this direction, because it makes possible a sufficiently great expansion of the laser beam (10) even in case of a small overall size.

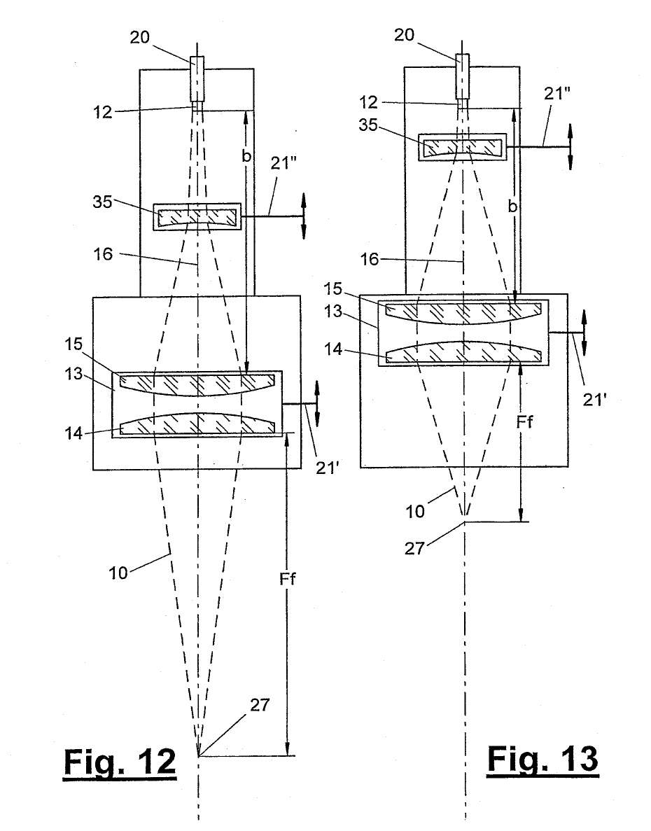

FIGS. 12 and 13 show another variant, in which the fiber mount (20) and the fiber decoupling point (12) are held stationarily and the divergent lens (35) as well as the laser lens system (13) are moved with adjuster devices (21″, 21′) in the beam direction (16). It is favorable in this connection always to move the two lenses (13, 35) in the same direction. When the laser lens system (13) approaches the fiber decoupling point (12) and the optical distance b is shortened, the divergent lens (35) also moves in the direction of the fiber decoupling point (12). Conversely, the divergent lens (35) moves towards the laser lens system (13) in case of an increase in the distance b. A comparison of FIGS. 10 and 11 with FIGS. 12 and 13 shows that equivalent changes in the focal length Ff can be brought about with both procedures.

It is possible in another variant to leave the optical distance b between the fiber decoupling point (12) and the collimating lens (15) or the laser lens system (13) constant and to move only the divergent lens (35) in the beam direction (16). This leads to a change in the divergence angle of the laser beam (10) falling on the collimating lens (15), which in turn leads to a change in the convergence angle of the focussed laser beam (10) at the point of incidence (28) on the workpiece (5). There also arises now a slight focus shift and possibly a deliberate or accepted defocussing.

Such changes in the spot diameter without excessively great focus shifts may be used, e.g., in case of laser beams (10) that fall on the workpiece with variable incidence angles, where projected focal spots of different sizes are formed in the projection at the different incidence angles. A shift of the divergent lens (35) as a function of the incidence angle can compensate these projection-related changes in spot size. This is brought about by the above-mentioned mathematical combination of the motions of the manipulator and the adjuster device (21″) in the control (4). The autofocus system thus also comprises an insulated adjustment of the divergent lens (35).

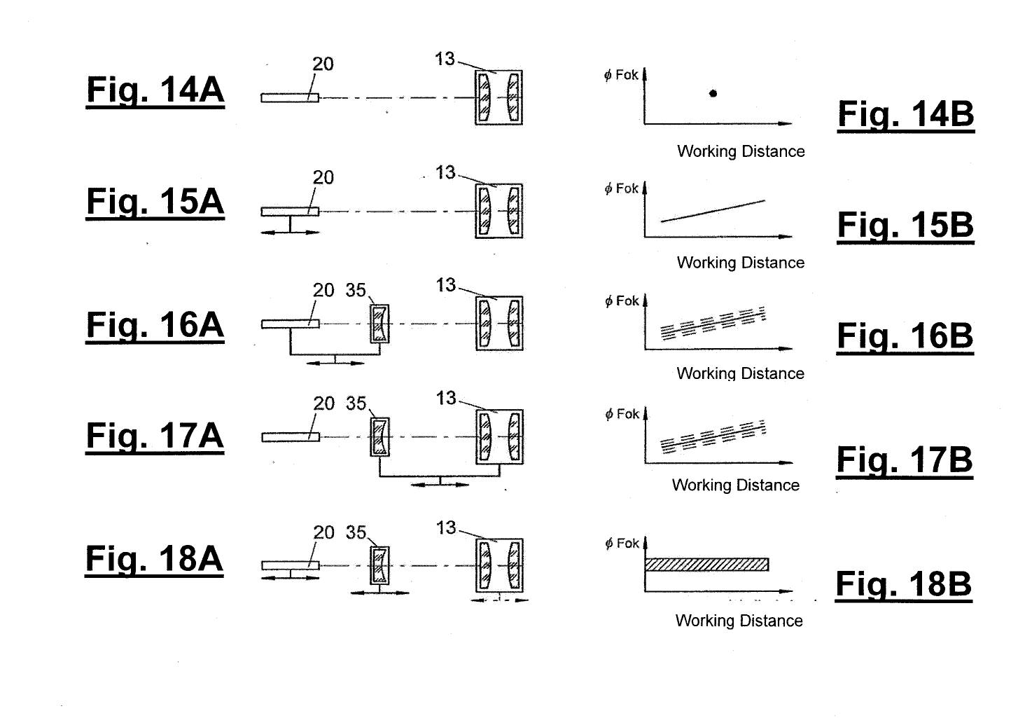

FIGS. 14A through 18B illustrate in diagrams an efficiency analysis of the above-mentioned possibilities of adjustment. FIGS. 14A and 14B shows the state of the art with a fixed optical distance b and stationary arrangement of the laser lens system (13) and the fiber mount (20). The focal length Ff and the working distance a of the laser tool (7) are fixed in this case, so that a fixed size of the spot diameter is obtained for the one value. FIG. 15 shows the first variant of the present invention according to FIGS. 1 and 2 with the movable fiber mount (20) and the stationary laser lens system (13). An essentially straight and obliquely rising characteristic is obtained in this arrangement for the increase in the spot diameter as a function of the variable focal length Ff and the correspondingly variable working distance a. The fiber mount (20) and the divergent lens (35) are coupled in the variant according to FIG. 16 and can be moved together in relation to the stationary laser lens system (13). This leads to a characteristic similar to that in FIGS. 15A and 15B, which may, however, be steeper because of the divergent lens (35). In addition, this characteristic may be shifted in parallel upward and downward when the divergent lens (35) moves independently in relation to the fiber mount and its distance changes. FIGS. 17A and 17B show another variant with a behavior similar to that in FIGS. 16A and 16B, but the divergent lens (35) is moved here together with the laser lens system (13) in relation to the relatively stationary fiber mount (20). A characteristic can be shifted in parallel upward and downward due to the independent mobility of the divergent lens (35) in relation to the fiber mount (20) in this case as well. FIGS. 18A and 18B show a third variant compared to FIGS. 16A and 16B and 17A and 17B. The divergent lens (35) is coupled with the fiber mount (20) or the laser lens system (13) in the variants according to FIGS., 16A and 16B and 17A and 17B and performs shifting motions together with same. However, the distance within the coupling can be set and changed here, so that the shifts of the characteristic arise. The divergent lens (35) can be moved by an adjusting drive (21″) of its own freely and independently in relation to the likewise independently movable fiber mount (20). As an alternative or in addition to the fiber mount (20), the laser lens system (13) may be movable. The performance graph shown in the diagram is obtained as a result for the changes of the working distance and the spot diameter, which is likewise adjustable here.

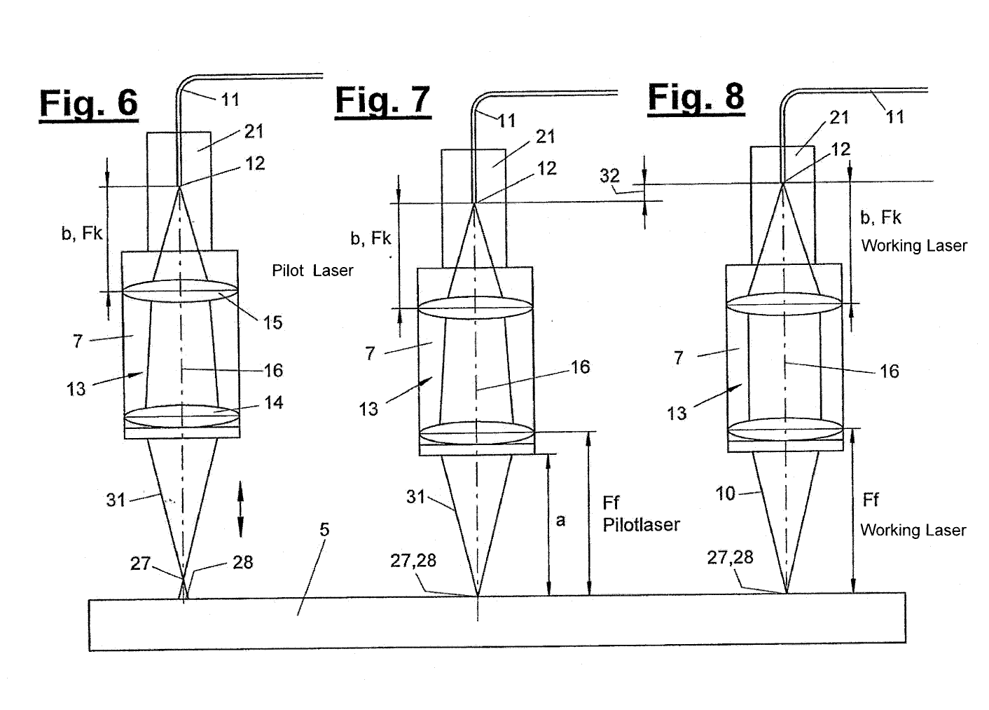

FIGS. 6 through 8 illustrate the procedure of teaching the laser tool (7) or the adjuster device(s) (21, 21′, 21″), which is especially advantageous in connection with an autofocus system connected to the manipulator control (4). To enable the autofocus system to adjust the focal length Ff precisely and continuously in the desired manner, the TCP is to be taught and set. The TCP is usually located in the focus (27), and a system of coordinates for tracking the path is also put up at this point. To make it possible to control the manipulator (2) and the working distance a correctly, the control (4) must cause the TCP and the focus (27) to overlap. The TCP also has a certain location, which is preset in the control, concerning distance and orientation in relation to at least one other manipulator reference point, e.g., a flange reference point in the manipulator hand (3), at which a system of coordinates of the flange is put up. The location of the flange reference point has, in turn, a certain relation to a manipulator foot and a world coordinate system located there.

A pilot laser beam (31), which has a wavelength in the visible range, e.g., 633 nm, is used for teaching. The working laser beam (10) has, by contrast, a substantially greater wavelength of approx. 1,060 to 1,080 nm, which is in the invisible infrared range. The different wavelengths lead to differences in the refraction characteristic and the focal lengths. This may lead to considerable changes in the location of the focus and in the focal length Ff, and the deviations may amount, e.g., to more than 50 mm. These differences can be compensated with the adjuster device (21) by means of an offset (32) in the optical distance b.

The pilot laser beam (31) is generated by a pilot laser (29), which may be accommodated in the laser source (8) or arranged externally. The pilot laser beam (31) is coupled into the beam path of the working laser beam (10) and into the optical waveguide (11). The coupling means (30) may have, e.g., a plurality of mirrors, also including partially transparent mirrors. The pilot laser beam (31) coupled instead of the working laser beam generates an optically visible focal point (28) on the workpiece.

The optical distance b is set to a selectable preset value for the pilot laser beam (31) and fixed in this position. This may happen in the various ways described above, e.g., by shifting the fiber decoupling point (12). In the next step, the laser tool (7) is approached or moved away in relation to the workpiece (5) by a relative motion in the beam direction (16) until the focal point (28) on the workpiece surface is correlated with the focus (27). The focal point (28) has, e.g., a sharply contoured and optically visible contour in this position. The pilot laser beam (31) or its beam path (16) is preferably directed essentially at right angles to the open workpiece surface during this approaching motion, and the relative motion also takes place in this beam direction (16). The relative motion may take place by a motion of the laser tool (7) towards the stationary workpiece (5), which is carried out by the manipulator (2), or with a kinematic reversal. As soon as the desired correlation between the focus (27), the focal point (28) and the TCP has been found, the corresponding position of the manipulator (2) is stored in the control (4). The relative motion between the laser tool (7) and the workpiece (5) may be carried out by a human operator by manual control of the manipulator (2).

The pilot laser beam (31) is switched off in the next step and the optical distance b is changed by an offset path (32), which corresponds to the wavelength difference between the working laser beam and the pilot laser beam, and, e.g., the fiber decoupling point (12) is shifted. The fiber decoupling point (12) is moved back and the optical distance b is increased in case of a working laser beam (10) having a longer wavelength. Due to this correction, which is likewise initiated by the control (4), the adjuster device (21) has a correct setting relative to the position of the TCP on the workpiece (5). The position of the linear drive (22) or of the fiber decoupling point (12) is likewise stored in the control (4). The teaching operation is thus concluded.

If the fiber decoupling point (12) is to have a certain position after teaching, the offset (32) starting herefrom is taken into account in the preset position for the pilot laser beam (31). The fiber decoupling point (12) is shifted forward by the offset (32) for this and the optical distance b is reduced corresponding to the shorter wavelength of the pilot laser beam (31).

An analogous procedure is obtained when the optical distance b is changed in the above-described manner by moving the collimating lens or the laser lens system (15, 13) and/or the divergent lens (35).

The pilot laser beam (31) can be used, moreover, to teach and set the adjusting means (33) and the lateral and transverse position of the laser beam. For example, the laser tool (7) is positioned for this by the manipulator (2) in a preset desired position in relation to the workpiece (5) and a reference feature located there, e.g., an optical point. The desired position is selected in terms of position and orientation such that with a preset setting of the adjuster device (21), the pilot laser beam (31) must meet the focus (27) exactly on this reference point. If there is a lateral deviation, the adjusting means (33) can be adjusted correspondingly for correction.

A so-called “focus shift” may occur in case of laser lens systems (13) with high-energy laser beams, especially welding or cutting lens systems, due to the heating of the welding lens system. The optical behavior of the optical components changes due to the temperature gradient in the optical components, and even a minimal deformation of these optical components may occur. The consequence of this is a shift of the focal point (27) in the beam direction (16). The direction of the shift depends on the selected structure of the laser lens system (13) and may amount to more than 5 mm. Correction and compensation of this focus shift is possible with the adjuster device (21).

This may happen in various ways. On the one hand, the temperature behavior of the laser lens system (13) can be determined and monitored by a temperature or heat measurement within the laser lens system (13) with one or more suitable heat-measuring means (34), e.g., temperature sensors. Changes in the position or shifts of the focus (27), which were determined empirically or in another manner and which can be compensated by means of the adjuster device (21) manually or automatically, can be assigned to these temperature values by means of a correlation table. A compensation factor or adjustment value for the adjuster device (21) can also be assigned to the temperature values right away on the basis of a table. As an alternative, a focus shift may be detected and signaled in any other desired and suitable manner as well.

The table may be stored in the control (4), so that the focus shift compensation can be carried out automatically in case of significant temperature changes. This is also a control of the focal point (27) by means of the autofocus function at the same time. Manual adjustment is otherwise also possible by bringing the laser tool (7) into a predetermined position in relation to the workpiece (5) and an adjustment being carried out in the above-described manner with the pilot laser beam (31) by examining the focal spot.

Various modifications of the embodiments shown are possible. This applies to the design embodiment of the laser tool (7), the laser source (8), the line (9) and other parts of the laser device (6). For example, a beam splitter may be present, which splits the entering laser beam (10) into two or more partial beams. Furthermore, it is possible to work with beam bundles or fiber bundles and thus to change the contour of the laser beam (10, 31) composed of a plurality of partial beams. The other components of the laser cell (1) may be modified in terms of design as well. The kinematics and the adjustability of the fiber mount (20) and of the fiber decoupling point (12) and the lens systems (13, 14, 15, 35) are variable as well. As was already mentioned above in connection with FIGS. 16 and 17, e.g., the divergent lens (35) may be mounted movably along the beam direction (16) and connected to the fiber mount (20) movable with the adjuster device (21) via a length-adjustable coupling member. As an alternative, such a coupling may be present between the divergent lens (35) and the collimating lens (15) or the laser lens system (13). Due to these variable-distance couplings, the divergent lens (35) can move synchronously with the fiber mount (20) or the collimating lens or the laser lens systems (15, 13). The coupling member may be, e.g., a traveling carriage, on which the divergent lens (35) is adjustably attached. The adjuster device (21″) may optionally be present at this attachment point, so that the position of the divergent lens (35) on the carriage can be adjusted in a remote-controlled manner. This coupling can be used above all in case of a stretched beam path (16), but it may also be used with a bent laser tool (7) with deflecting mirror (18) by means of a flexible coupling.

While specific embodiments of the invention have been shown and described in detail to illustrate the application of the principles of the invention, it will be understood that the invention may be embodied otherwise without departing from such principles.

1. A method for operating a laser device, the method comprising:
providing a laser tool, which has a laser lens system with a focusing lens and a collimating lens as well as a connector for an optical waveguide with a fiber decoupling point; and
changing a focal length of said focussing lens by adjusting an optical distance of said fiber decoupling point from said collimating lens.

2. A method in accordance with claim 1, wherein the size of a focal spot on a workpiece is changed by adjusting said optical distance and/or by adjusting a divergent lens relative to said fiber decoupling point.

3. A method in accordance with claim 2, wherein said fiber decoupling point at said connector and/or said collimating lens and/or said divergent lens are shifted in said beam direction by means of a motor-driven adjuster device in a remote-controllable manner.

4. A method in accordance with claim 1, wherein said focal length of said focusing lens and/or the size of a focal spot are adjusted automatically in an autofocus system in case of changes in the orientation of said laser tool.

5. A method in accordance with claim 1, wherein said focal length of said focusing lens is adjusted automatically or manually in case of a focus shift of said laser tool.

6. A method in accordance with claim 1, wherein an adjuster device is connected to a control of a multiaxial manipulator, which guides said laser tool or a workpiece, the motions of said adjuster device and of said manipulator being combined mathematically.

7. A method in accordance with claim 6, wherein to teach said laser tool and said adjuster device as well as said manipulator, an optically visible pilot laser beam is coupled into said optical waveguide and directed by said laser tool from a desired position toward a workpiece to be processed, said adjuster device and/or said manipulator being adjusted manually until said focal point is imaged correctly on said workpiece.

8. A method in accordance with claim 7, wherein for teaching, said optical distance is adjusted automatically by a offset path corresponding to the different wavelengths of the pilot laser beam and the working laser beam.

9. A laser device comprising:
a laser tool, which has a laser lens system with a focusing lens and a collimating lens as well as a connector for an optical waveguide with a fiber decoupling point,
a laser tool adjuster device for adjusting said optical distance of said fiber decoupling point from said collimating lens for changing a focal length of said focusing lens.

10. A laser device in accordance with claim 9, wherein said laser tool adjuster device is further for adjusting a divergent lens relative to said fiber decoupling point.

11. A laser device in accordance with claim 10, wherein said adjuster device is arranged at said connector and/or at said collimating lens and brings about a shift of said fiber decoupling point and/or said collimating lens in said beam direction.

12. A laser device in accordance with claim 9, wherein said adjuster device has a controllable linear drive.

13. A laser device in accordance with claim 10, wherein said linear drive has a hollow drive housing with an adjusting member, which is axially displaceable by means of a motor on the inner side and to which said optical waveguide or said collimating lens or said divergent lens is attached.

14. A laser device in accordance with claim 9, wherein said optical waveguide has a fiber mount, comprising a fiber plug, which is detachably attached to said adjusting member.

15. A laser device in accordance with claim 9, wherein said linear drive has a measuring means (26) for measuring the path of said adjusting member (25).

16. A laser device in accordance with claim 12, wherein said linear drive has a programmable control with a computing unit and with at least one memory for programs, measured path values and offset values.

17. A laser device in accordance with claim 9, wherein said linear drive is connected to said control of a multiaxial manipulator which guides said laser tool or said workpiece.

18. A laser device in accordance with claim 9, wherein said adjuster device is designed as an autofocus system, which automatically adjusts said focal length Ff in case of changes in the orientation of said laser tool.

19. A laser device in accordance with claim 9, wherein said adjuster device is designed as an automatic or manual adjusting means for a focus shift and is connected to a heat-measuring means in or at said laser tool.

20. A laser device in accordance with claim 9, wherein said laser lens system focusing and collimating lens are stationary relative to one another.

21. A laser device in accordance with claim 9, wherein a focal length of said collimating lens is smaller than said focal length of said focusing lens.

22. A laser device in accordance with claim 9, wherein an initial focal length of said focusing lens is greater than 500 mm.

23. A laser device in accordance with claim 9, further comprising a laser source for providing a working laser light and a pilot laser for an optically visible pilot laser light as well as a means (30) for coupling the pilot laser light into said optical waveguide.
